(19) United States
(12) Patent Application Publication
(10) Pub. No.: US 2010/0319575 A1
(43) Pub. Date: Dec. 23, 2010

(54) COATINGS AND FILMS

(75) Inventors: Sonya Buchner, Pretoria (ZA); John Reginald Nuttall Taylor, Menlo Park (ZA)

Correspondence Address: SEED INTELLECTUAL PROPERTY LAW GROUP PLLC, 701 FIFTH AVE, SUITE 5400, SEATTLE, WA, 98104, US

(73) Assignee: CSIR, Pretoria (ZA)

(21) Appl. No.: 12/294,879

(22) PCT Filed: Mar. 7, 2007
(86) PCT No.: PCT/IB07/50754

§ 371 Date: Sep. 7, 2010

(30) Foreign Application Priority Data
Mar. 27, 2006 (ZA) 2006/02490

(51) Int. Cl. C09D 189/00

(52) U.S. Cl. 106/135.1

(57) ABSTRACT

A composition from which a coating or film can be formed comprises at least one prolamin protein, gluconic acid and/or a gluconic acid derivative as a plasticizer, and a solvent for the protein and the plasticizer. The composition is in the form of a solution.

THIS INVENTION relates to coatings and films. It relates in particular to a composition from which a coating or film can be formed, and to a coating or film when formed from such a composition.

According to a first aspect of the invention, there is provided a composition from which a coating or film can be formed, the composition comprising
at least one prolamin protein;
as a plasticizer, gluconic acid and/or a gluconic acid derivative; and
a solvent for the protein and the plasticizer, so that the composition is in the form of a solution.

It is to be appreciated that when the various components of the composition are food grade, a coating or film obtained from the composition can safely be ingested. Furthermore, it is believed that coatings obtained from the composition will have particular application to edible products or foodstuffs, such as fruit and vegetables, or other ingestible products, such as solid pharmaceutical products, eg pills or tablets, without imparting offensive tastes, eg sour tastes, to the products.

Prolamin proteins are simple proteins found in plants, and typically contain hydrophobic amino acids such as leucine, proline and alanine, as well as glutamine. In particular, the prolamin protein may be a grain or cereal protein such as zein, which is found in maize, or kafirin found in sorghum; however, kafirin is preferred. There are two primary reasons why kafirin is the preferred prolamin protein. Overall, it is more hydrophobic than other prolamins such as wheat gliadin and maize zein (Duodu, KG et al. Journal of Cereal Science 38:117-131). Hence, it should be a better moisture barrier. It is also more cross-linked than zein (Duodu, KG et al. Journal of Cereal Science 38:117-131), especially after having been subjected to thermal treatment, as is the case in film or coating making. Hence, it should have greater mechanical strength.

If desired, a mixture or combination of prolamin proteins can be used. When a combination of prolamin proteins are used, kafirin preferably constitutes a major proportion, i.e. more than 50% (by mass) of the combination of prolamin proteins.

Preferably, glucono δ-lactone, which is also known as D-gluconic acid δ-lactone or D-glucono-1,5-lactone, and which is hereinafter also referred to as ‘GDL’, is used as the plasticizer. Glucono delta-lactone (the cyclic 1,5-intramolecular ester of gluconic acid) is the preferred form of gluconic acid because it is used in the food industry as a processing aid according to good manufacturing practice (GMP conditions). GDL is a white, odourless, crystalline powder that is freely soluble in water and moderately soluble in alcohol. It hydrolyses to gluconic acid in water and is known to impart much less tartness than other acidulants. It is generally recognized as safe (GRAS) as a human food ingredient, meets the specifications of the Food Chemicals Codex (3d Ed, 1981) and is listed as a generally permitted food additive (E575) by the European Parliament and Council Directive No 95/2/EC. (Anon., 2002. USDA National Organics Standards Board (NOSB) Technical Advisory Panels (TAP) materials database compiled by OMRI (Organic Materials Review Institute). www.omri.org/GDL.pdf, 14 Nov., 2005).

The composition may include a secondary plasticizer, in addition to the other or main plasticizer. Thus, the secondary plasticizer, when present, is different to the main plasticizer, ie it is not gluconic acid and/or a gluconic acid derivative. The secondary plasticizer may, for example, be a food grade acid such as lactic acid, or a polyol such as propylene glycol, glycerol or polyethylene glycol.

When the secondary plasticizer is also present, the mass proportion of main plasticizer to secondary plasticizer may be from 1:9 to 9:1. Typically, the mass proportion of main plasticizer to secondary plasticizer in the composition may be about 1:2, when the composition is to be used to produce coatings and free standing films.

The mass proportion of plasticizer, ie main plasticizer on its own or main and secondary plasticizers combined, to protein in the composition may be from 1:1 to 1:9. Typically, the mass proportion of plasticizer to protein in the composition may be about 1:2.

The solvent may be a concentrated or strong alcohol, an organic acid, or a combination of a strong alcohol and an organic acid. The alcohol or organic acid is preferably one that readily evaporates, to facilitate formation of a coating or film from the composition. Thus, when an alcohol is used as solvent, it may be ethanol or propanol. When an organic acid is used as the solvent, it may be glacial acetic acid. The strong or concentrated alcohol solution may contain at least 50% (v/v) alcohol, with the balance being water. Typically, the alcohol solution may comprise 70% (v/v) alcohol.

For either coating or film production, the composition may comprise up to 25% (by mass) protein and plasticizer combined. The composition may comprise from 1% to 15% (by mass), typically about 3% (by mass) protein and plasticizer combined, for coating production, and from 5% to 20% (by mass), typically about 13% (by mass), protein and plasticizer combined, for film production. The balance of the composition will thus be solvent.

When the composition is to be used for film production, the various components of the composition may be admixed; heated, eg to a temperature of about 70° C., and maintained at such temperature for a period of time, eg for about 10 minutes; and thereafter cast onto a casting surface.

However, when the composition is to be used for coating production, the prolamin protein and solvent may first be admixed, and the resultant solution subjected to heat treatment, eg at 70° C. for a period of time, eg about 20 minutes, accompanied by mixing, with solvent make-up as necessary to adjust for solvent loss through evaporation at the elevated temperature. The solution is then preferably allowed to cool to room temperature and subjected to a waiting period, eg of about 16 hours, to relax the protein. Thereafter, the plasticizers may be added to the solution, whereafter the solution may again be heated, eg to about 70° C., solvent added if necessary to make up for evaporation losses, and the resultant composition allowed to cool to room temperature, before coating the products therewith, eg by dipping the products in the composition or spraying the solution onto the products.

According to a second aspect of the invention, there is provided a coating or film which comprises
at least one prolamin protein; and
as a plasticizer, gluconic acid and/or a gluconic acid derivative.

The protein and plasticizer may be as hereinbefore described. The coating or film may include a secondary plasticizer as also hereinbefore described.

The coating or film may be that obtained by removing the solvent from a composition according to the first aspect of the invention. The removal of the solvent is preferably effected by allowing the solvent to evaporate, with or without the application of heat and/or air flow. More specifically, the coating or film may be that obtained by covering a surface with a composition according to the first aspect of the invention, and allowing the solvent to evaporate, thereby to form the coating or the film on the surface.

In one embodiment of the invention, a free-standing film may be provided. The film will then typically have a thickness of about 100 microns (μm). However, in another embodiment of the invention, a coating may be provided. The coating may then typically have a thickness of 15-20 μm.

In one embodiment of the invention, the surface which is covered with the composition may be that of an ingestible foodstuff or product such as an edible product, eg a fruit or a vegetable, or a non-edible product such as a flower, or a pharmaceutical product such as a pill or tablet. The resultant coating will thus be in the form of a protective coating around the product. When the product is an edible product, all the components or ingredients of the composition may be food grade so that the protective coating is edible. Instead, the product can be a non-food material such as cellulosic material, eg paper, with the paper thus being coated with the composition to form a laminated material. The covering of the product may be effected by dipping the product in the composition. The thickness of the coating will then typically be in the order of 15-20 μm as hereinbefore described.

However, in another embodiment of the invention, the surface which is covered with the composition may be a casting surface, with the composition being cast thereon in a thickness which is sufficient so that the film that is formed, is free-standing. The thickness of the film may then typically be about 100 μm, as also hereinbefore set out. More particularly, the solvent may be allowed to evaporate at elevated temperature. Thus, the cast composition may be subjected to drying at elevated temperature, eg at about 50° C., for a period of time, eg for about 4 hours, for the free standing film to form.

The invention will now be described in more detail with reference to the following non-limiting examples:

### EXAMPLE 1

Packham's Triumph pears were harvested when physiologically mature, but still unripe. The pears were packed in cartons, and the packed cartons placed in refrigerated storage.

A composition according to one embodiment of the invention, and which was in the form of a solution, was made up by admixing the following (all percentages are given on a mass basis): 2.00% kafirin (pure protein basis), 0.36% GDL as a main plasticizer, 0.72% propylene glycol as a secondary plasticizer and acidulant, and 96.5% of a strong alcohol solution comprising 70% (v/v) ethanol in water. The protein (kafirin) and plasticizers (GDL and propylene glycol) thus constituted about 3.5% of the composition, with the proteins comprising 68.9% of the non-solvent components in the composition.

The coating solution was prepared by weighing the kafirin into an Erlenmeyer flask. Warm (70° C.) aqueous ethanol was added. The weight of the container and its contents was noted. The mixture was heated in a 70° C. water bath while it was stirred rapidly (using overhead stirrer) for 20 minutes. The flask and its contents were reweighed and 70% (v/v) aqueous ethanol added until the original weight of the mixture was obtained (to replace ethanol lost during evaporation). The mixture was left overnight (16 hours), at room temperature, to relax the protein because it was observed that the relaxing period improved the appearance of the final coating.

Two to four hours prior to coating the pears, the plasticizer mixture was weighed into the ethanol/kafirin solution. The container and solution weight was noted. The solution was heated in a 70° C. water bath while being stirred continuously until it reached 70° C. Aqueous ethanol (70%, v/v) was added to replace amount lost during evaporation, after which the container was covered and left to cool to 20-25° C.

Sixteen hours prior to coating, all the pears (still unripe) were removed from refrigerated storage and from the carton boxes in which they had been stored, and left at 20° C. to equilibrate overnight. The pears were each dipped into ±300 ml coating solution, for five seconds and hung up by the stem to dry for four hours at 20° C. The coating solution could also be applied to the fruit by spraying or any means that allows the coating solution to make direct contact with the fruit without the use of an intermediate applicator like a brush.

Packham's Triumph pears were thus coated in this manner, to determine the effect of the coatings on the post-harvest response and shelf life of the pears, by studying changes in physical, chemical and sensory properties as well as microbiological quality over the storage period of 24 days.

It was found that the coating allowed for aerobic respiration of the pears, and hence normal flavour, colour and textural development of the pears. It was further found that the coating was able to extend the shelf life of the pears significantly by decreasing the ripening rate of the coated fruit. For coated pears, optimum eat ripe quality was attained after 10 and 14 days of storage, whereas uncoated pears were perceived to be eat ripe after 7 days of storage at 20° C.

According to descriptive sensory results obtained, the coatings nearly doubled the shelf life of the pears. It was found that the coating was able to decrease the respiration rate and retard the progression of the senescence phase of the fruit. The coating was most effective in inhibiting de-greening. Microbiological data suggested that, in all instances, the levels of bacteria on the coated and uncoated pears were low. Apart from lower levels of mould growth on the coated pears, the coatings did not appear to significantly affect the microbiological quality of the pears during storage at 20° C.

The coatings were typically 15-20 μm thick. The coatings were thus composite, edible, protein-based coatings which were able to delay ripening and loss in quality of the pears by acting primarily as gas barriers around the fruit. However, the coatings still provided sufficient gas permeability for the pears to take up sufficient oxygen to sustain their normal functioning, albeit at a slower rate than their normal respiration rate, with carbon dioxide and moisture being released by the fruit. It is believed that the limitation of oxygen decreased the rate of pear metabolism, thereby extending the shelf life of the pears.

The respiration pattern of climacteric fruit is often used as an indication of the physiological status of the fruit. Climacteric fruit are harvested at physiological maturity but still unripe. At this stage, the respiration rate is at a minimum, and this is referred to as the pre-climacteric minimum. Climacteric development follows, and is characterized by a sharp increase in respiration rate coinciding with physiological and biochemical changes in the fruit that occur simultaneously but which are not necessarily interdependent. The respiration rate increases until a climacteric maximum (eating ripeness) is reached after which senescence sets in, characterized by a rapid decline in fruit quality. Fruit quality can be defined as certain characteristics of the fruit such as colour, firmness, organic acid or sugar content. It is thus desirable, in respect of fruit export or distribution, to preserve the fruit quality by retarding the climacteric development, and ultimately delaying the climacteric maximum.

In many countries, including Southern African countries, the export of deciduous fruit, of which many are climacteric, is an important industry. However, in order to comply with high quality standards of foreign consumers, it is crucial that fruit quality changes, and in particular post-harvest fruit decay, occur minimally during export. It is believed that this can be achieved with edible coatings according to the invention.

Additionally, in many fruit producing countries, such as Southern African countries, there are significant cereal industries which produce substantial quantities of waste (protein-rich by-products) during processing of the grains. These protein-rich by-products are inexpensive resources, readily available for use in forming compositions according to the invention.

The coatings of the invention can be applied not only on climacteric fruit as hereinbefore described, but also on non-climacteric fruit such as grapes, strawberries and citrus fruit, to provide moisture barriers, provide physical and microbiological protection as hereinbefore described, and to enhance visual appeal. The fruit can be unprocessed fruit, or minimally processed (peeled and/or cut only) fruit. The coatings can also be applied to other edible products such as vegetables and even on non-edible products such as flowers.

### EXAMPLE 2

To test the concept of the coating for oranges, Valencia oranges were purchased from a local green grocer. Oranges were washed in warm (70° C.) ethanol to remove the wax coating, wiped down with a dry towel and allowed to dry in a fume hood for an hour. Oranges were kept at room temperature (16-18° C.) for 12 hours prior to coating.

A composition according to another embodiment of the invention, and which was in the form of a solution, was made up by admixing the following (all percentages are given on a mass basis): 3.00% kafirin (pure protein basis), 0.8% GDL as a main plasticizer, 1.07% propylene glycol as a secondary plasticizer, and as solvents 0.25% glacial acetic and 94.88% of a strong alcohol solution comprising 70% (v/v) ethanol in water. The protein (kafirin) and plasticizers (GDL and propylene glycol) thus constituted about 4.87% of the composition, with the proteins comprising 61.6% of the non-solvent components in the composition.

The coating solution was prepared by weighing the kafirin into an Erlenmeyer flask. Glacial acetic acid and warm (70° C.) aqueous ethanol was added. The weight of the container and its contents was noted. The mixture was heated in a 70° C. water bath while it was stirred rapidly (using overhead stirrer) for 20 minutes. The flask and its contents were reweighed and 70% (v/v) aqueous ethanol added until the original weight of the mixture was obtained (to replace ethanol lost during evaporation). The mixture was left overnight (16 hours), at room temperature, to relax the protein because it was observed that the relaxing period improved the appearance of the final coating.

Two to four hours prior to coating the oranges, the plasticizer mixture was weighed into the ethanol/kafirin solution. The container and solution weight was noted. The solution was heated in a 70° C. water bath while being stirred continuously until it reached 70° C. Aqueous ethanol (70%, v/v) was added to replace the amount lost during evaporation, after which the container was covered and left to cool to 30° C. before dipping the oranges. Only half of the orange was dipped in the coating solution before being placed in a fume cupboard by resting on the uncoated side to allow for solvent evaporation and drying of the coated side (for 2 hours). The procedure was followed again to coat the remaining half of the orange.

The oranges were coated and stored along with uncoated oranges at 27° C. for 14 days after which coated oranges were observed for whitening, gloss, and flaking of the coating. Oranges were also cut open and the smell and taste evaluated informally for the presence of any off-flavours.

The coating on the oranges appeared glossy, did not flake, whiten or impart different or off-flavours or aromas to the oranges.

### EXAMPLE 3

A composition according to another embodiment of the invention, and which was also in the form of a solution, was made up by admixing the following (all percentages are given on a mass basis): 10.2% kafirin (pure protein basis), 1.9% GDL, as a main plasticizer, 3.7% propylene glycol as a secondary plasticizer and 84.1% of a strong alcohol solution comprising 70% (w/w) ethanol in water. The protein (Kafirin) and plasticizers (GDL and lactic acid) thus constituted 15.1% of the composition, with the proteins comprising 67.5% of the non-solvent components used to form the composition. The solution was heated to 70° C. and then maintained at this temperature with vigorous stirring for 10 minutes. After 10 minutes the solution was removed from the heat. Strong alcohol (99.9%) was added to maintain the original weight, replacing the strong alcohol, which had evaporated on heating. Aliquots were removed and cast into clean, dry flat plastic containers. The containers were placed on a level surface in an oven (not forced draft) at 50° C. and dried for 4 hours. Films were gently peeled from the casting containers. Tensile and water barrier properties of the free standing films were then determined.

It was found that the inclusion of GDL as the main plasticizer increased the elongation of free standing kafirin films by about 10 fold and decreased the tensile stress by about 4 times.

It is to be appreciated that the thickness of the free-standing film or of the coating, as the case may be, can be varied, to obtain different properties. Similarly, the exact make-up of the composition can be varied, to impart different properties to the resultant films.

1. A composition from which a coating or film can be formed, the composition comprising
at least one prolamin protein;
as a plasticizer, gluconic acid and/or a gluconic acid derivative; and
a solvent for the protein and the plasticizer, so that the composition is in the form of a solution.

2. A composition according to claim 1, wherein the prolamin protein is kafirin.

3. A composition according to claim 1, wherein a combination of prolamin proteins is present, with kafirin constituting a major proportion of the combination of prolamin proteins.

4. A composition according to any one of claims 1 to 3 inclusive, wherein the plasticizer is glucono delta-lactone.

5. A composition according to any one of claims 1 to 4 inclusive, which includes a secondary plasticizer, in addition to the other or main plasticizer, with the secondary plasticizer being different to the main plasticizer.

6. A composition according to claim 5, wherein the mass proportion of main plasticizer to secondary plasticizer is from 1:9 to 9:1.

7. A composition according to any one of claims 1 to 6 inclusive, wherein the mass proportion of plasticizer to protein is from 1:1 to 1:9.

8. A composition according to any one of claims 1 to 7 inclusive, wherein the solvent is a concentrated or strong alcohol and/or an organic acid.

9. A composition according to any one of claims 1 to 8 inclusive, which comprises up to 25% (by mass) protein and plasticizer combined.

10. A composition according to claim 9, which comprises from 1% to 15% (by mass) protein and plasticizer combined, for coating production for edible foodstuffs.

11. A composition according to claim 9, which comprises from 5% to 20% (by mass) protein and plasticizer combined, for film production.

12. A coating or film which comprises
at least one prolamin protein; and
as a plasticizer, gluconic acid and/or a gluconic acid derivative.

13. A coating or film according to claim 12, wherein the prolamin protein is kafirin.

14. A coating or film according to claim 12, wherein a combination of prolamin proteins is present, with kafirin constituting a major proportion of the combination of prolamin proteins.

15. A coating or film according to any one of claims 12 to 14 inclusive, wherein the plasticizer is glucono delta-lactone.

16. A coating or film according to any one of claims 12 to 15 inclusive, which includes a secondary plasticizer, in addition to the other or main plasticizer, with the secondary plasticizer being different to the main plasticizer.

17. A coating or film according to claim 16, wherein the mass proportion of main plasticizer to secondary plasticizer is from 1:9 to 9:1.

18. A coating or film according to any one of claims 12 to 17, wherein the mass proportion of plasticizer to protein in the coating or film is from 1:1 to 1:9.
